(19) United States
(12) Patent Application Publication
(10) Pub. No.: US 2018/0324701 A1
(43) Pub. Date: Nov. 8, 2018

(54) EFFICIENT RETRANSMISSIONS FOR WAKEUP RADIOS

(71) Applicant: QUALCOMM Incorporated, San Diego, CA (US)

(72) Inventors: Yanjun Sun, San Diego, CA (US); Alfred Asterjadhi, San Diego, CA (US); George Cherian, San Diego, CA (US); Abhishek Pramod Patil, San Diego, CA (US); Yan Zhou, San Diego, CA (US); Bin Tian, San Diego, CA (US)

(21) Appl. No.: 15/970,374

(22) Filed: May 3, 2018

Related U.S. Application Data
(60) Provisional application No. 62/502,460, filed on May 5, 2017.

(51) Int. Cl. H04W 52/02; H04L 1/18; H04W 4/06

(52) U.S. Cl. CPC H04W 52/0235; H04W 52/0219; H04W 4/06; H04L 1/189

(57) ABSTRACT

Methods, systems, and devices for wireless communication are described. An access point (AP) may broadcast or multicast a wakeup transmission to wakeup radios (WURs) of a group of wireless and determine to retransmit the first wakeup transmission (e.g., for redundancy). The AP may transmit a second wakeup transmission to the WURs, the second wakeup transmission including an indication that the second wakeup transmission is a retransmission of the first wakeup transmission. The wireless devices may receive the indication that the second wakeup transmission is a retransmission, and may power up a main radio to receive a beacon based on whether or not the previous or originally wakeup transmission was received (e.g., determined via the indication included in the received wakeup message). In some cases, the AP may identify that some wireless devices failed to receive the first wakeup transmission, and may transmit a second wakeup transmission to those identified stations.

### CROSS REFERENCES

The present Application for Patent claims benefit of U.S. Provisional Patent Application No. 62/502,460 by SUN, et al., entitled “Efficient Retransmissions For Wakeup Radios,” filed May 5, 2017, assigned to the assignee hereof, and expressly incorporated by reference in its entirety.

### BACKGROUND

The following relates generally to wireless communication, and more specifically to efficient retransmissions for a wakeup radio (WUR).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include AP that may communicate with one or more stations (STAs) or mobile devices. The access point (AP) may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

A wireless device may have a limited amount of battery power. In some cases, it may be beneficial for a main radio (e.g., of a wireless device) to remain in a sleep mode or low power mode for extended periods of time. During a sleep mode, a wireless device may periodically activate a radio, such as a wakeup receiver of a WUR, to listen for and decode a wakeup signal (e.g., wakeup or WUR messages or paging messages) from an AP. The wireless device may then power on a main radio of the wireless device in response to receiving the wakeup signal from an AP.

In some cases, an AP may send (e.g., broadcast or transmit to a group of STAs) wakeup messages to a WUR (e.g., in particular the wakeup receiver) of one or more STAs, indicating that the AP has some data to transmit via the main radio to the STAs. That is, STAs may monitor for wakeup messages (e.g., paging messages) using a WUR, and the wakeup messages may indicate the presence of a beacon to be received via the main radio of the STA. As such, the STA may receive a wakeup message and wake up or power on a main radio for subsequent reception of a beacon transmission (or other transmission) from the AP. For broadcast or multicast wakeup messages, information may be intended for multiple STAs (e.g., a group of STAs), and certain messages may be sent more than once (e.g., wakeup or paging messages may be retransmitted by an AP multiple times to ensure receipt by STAs). In such cases, a STA may receive a retransmitted wakeup message and power on a primary radio (main radio) to receive redundant information already received by the STA, which may unnecessarily consume power. Improved techniques for efficient retransmission of wakeup messages may thus be desired.

### SUMMARY

The described techniques relate to improved methods, systems, devices, or apparatuses that support efficient retransmissions for wakeup radios (WURs). Generally, the described techniques provide transmitting, by an access point (AP), a first wakeup transmission to wakeup radios (e.g., in particular the wakeup receivers) of a group of stations, determining to retransmit the first wakeup transmission to the group of stations, and transmitting a second wakeup transmission to the wakeup radios of the group of stations. The second wakeup transmission may include an indication that the second wakeup transmission is a retransmission of the first wakeup transmission. Described techniques additionally provide for transmitting, by an AP, a first wakeup transmission to wakeup radios (e.g., the wakeup receivers) of a group of stations. The first wakeup transmission may be addressed to the group of stations, and may indicate to each station of the group of stations to power on a second radio to communicate with the access point. The AP may identify that one or more stations of the group of stations failed to receive the first wakeup transmission, and may transmit a second wakeup transmission to the identified one or more stations, the second wakeup transmission addressed individually to the one or more stations.

Techniques described herein also provide for receiving, at a wakeup radio of the station, a first wakeup transmission for a group of stations that includes the station. The first wakeup transmission may be addressed to the group of stations, including the station, and may indicate to the station to power on a second radio of the station to communicate with an access point. Techniques described may further include identifying that the first wakeup transmission is a retransmission of a prior wakeup transmission for the group of stations based at least in part on an indication included in the first wakeup transmission.

The described techniques relate to improved methods, systems, devices, or apparatuses that support efficient retransmissions for wakeup radios (WURs). Generally, the described techniques provide transmitting, by an access point (AP), a first wakeup transmission to wakeup radios of a group of stations, determining to retransmit the first wakeup transmission to the group of stations, and transmitting a second wakeup transmission to the wakeup radios of the group of stations. The second wakeup transmission may include an indication that the second wakeup transmission is a retransmission of the first wakeup transmission. Described techniques additionally provide for transmitting, by an AP, a first wakeup transmission to wakeup radios of a group of stations. The first wakeup transmission may be addressed to the group of stations, and may indicate to each station of the group of stations to power on a second radio to communicate with the access point. The AP may identify that one or more stations of the group of stations failed to receive the first wakeup transmission, and may transmit a second wakeup transmission to the identified one or more stations, the second wakeup transmission addressed individually to the one or more stations.

Techniques described herein also provide for receiving, at a wakeup radio of the station, a first wakeup transmission for a group of stations that includes the station. The first wakeup transmission may be addressed to the group of stations, including the station, and may indicate to the station to power on a second radio of the station to communicate with an access point. Techniques described may further include identifying that the first wakeup transmission is a retransmission of a prior wakeup transmission for the group of stations based at least in part on an indication included in the first wakeup transmission.

The method may include receiving, at a wakeup radio of a station, a first wakeup transmission addressed to a group of stations that includes the station, wherein the first wakeup transmission indicates to the station to power on a second radio of the station to communicate with an access point and identifying that the first wakeup transmission is a retransmission of a prior wakeup transmission for the group of stations based at least in part on an indication included in the first wakeup transmission.

An apparatus for wireless communication is described. The apparatus may include means for receiving, at a wakeup radio of the station, a first wakeup transmission for a group of stations that includes the station, the first wakeup transmission addressed to the group of stations, including the station, and the first wakeup transmission indicating to the station to power on a second radio of the station to communicate with an access point and means for identifying that the first wakeup transmission is a retransmission of a prior wakeup transmission for the group of stations based at least in part on an indication included in the first wakeup transmission.

Another apparatus for wireless communication is described. The apparatus may include a processor, memory in electronic communication with the processor, and instructions stored in the memory. The instructions may be operable to cause the processor to receive, at a wakeup radio of a station, a first wakeup transmission addressed to a group of stations that includes the station, wherein the first wakeup transmission indicates to the station to power on a second radio of the station to communicate with an access point and identify that the first wakeup transmission is a retransmission of a prior wakeup transmission for the group of stations based at least in part on an indication included in the first wakeup transmission.

A non-transitory computer readable medium for wireless communication is described. The non-transitory computer-readable medium may include instructions operable to cause a processor to receive, at a wakeup radio of a station, a first wakeup transmission addressed to a group of stations that includes the station, wherein the first wakeup transmission indicates to the station to power on a second radio of the station to communicate with an access point and identify that the first wakeup transmission is a retransmission of a prior wakeup transmission for the group of stations based at least in part on an indication included in the first wakeup transmission.

Some examples of the method, apparatus, and non-transitory computer-readable medium described above may further include processes, features, means, or instructions for determining that the station failed to receive the prior wakeup transmission. Some examples of the method, apparatus, and non-transitory computer-readable medium described above may further include processes, features, means, or instructions for powering on the second radio of the station to communicate with the access point based at least in part on receiving the first wakeup transmission.

Some examples of the method, apparatus, and non-transitory computer-readable medium described above may further include processes, features, means, or instructions for receiving, at the wakeup radio of the station, the prior wakeup transmission. Some examples of the method, apparatus, and non-transitory computer-readable medium described above may further include processes, features, means, or instructions for refraining from powering on the second radio of the station to communicate with the access point in response to the first wakeup transmission based at least in part on the identifying that the indication that the first wakeup transmission may be the retransmission of the prior wakeup transmission.

In some examples of the method, apparatus, and non-transitory computer-readable medium described above, the indication that the first wakeup transmission may be the retransmission of the prior wakeup transmission comprises a first sequence number. Some examples of the method, apparatus, and non-transitory computer-readable medium described above may further include processes, features, means, or instructions for comparing the first sequence number included in the first wakeup transmission to a second sequence number in the prior wakeup transmission. In some examples of the method, apparatus, and non-transitory computer-readable medium described above, the first sequence number is included in a type dependent control field of the first wakeup transmission.

In some examples of the method, apparatus, and non-transitory computer-readable medium described above, the first wakeup transmission may be scrambled based at least in part on a scrambling sequence. Some examples of the method, apparatus, and non-transitory computer-readable medium described above may further include processes, features, means, or instructions for identifying that the first wakeup transmission is the retransmission of the prior wakeup transmission for the group of stations by being configured to identify a successful descrambling sequence of one or more candidate descrambling sequences and determining that the first wakeup transmission is the retransmission of the prior wakeup transmission based at least in part on the identified successful descrambling sequence.

In some cases, identifying that the first wakeup transmission may be the retransmission of the prior wakeup transmission for the group of stations comprises: identifying a successful descrambling sequence of one or more candidate descrambling sequences. Some examples of the method, apparatus, and non-transitory computer-readable medium described above may further include processes, features, means, or instructions for determining that the first wakeup transmission may be the retransmission of the prior wakeup transmission based at least in part on the identified successful descrambling sequence.

In some examples of the method, apparatus, and non-transitory computer-readable medium described above, the first wakeup transmission comprises a unicast transmission addressed to the station. Some examples of the method, apparatus, and non-transitory computer-readable medium described above may further include processes, features, means, or instructions for receiving an indication of a time window for the first wakeup transmission. In some examples of the method, apparatus, and non-transitory computer-readable medium described above, the time window is for wakeup transmissions that are broadcast, or multicast, or a combination thereof. In some examples of the method, apparatus, and non-transitory computer-readable medium described above, the time window comprises a periodicity, an offset from a reference point in time, a length of the time window, or a combination thereof. In some examples of the method, apparatus, and non-transitory computer-readable medium described above, the first wakeup transmission is received in a first time window and the prior wakeup transmission is received in a prior transmission window.

A method of wireless communication is described. The method may include transmitting a first wakeup transmission to wakeup radios of a group of stations, determining to retransmit the first wakeup transmission to the group of stations, and transmitting a second wakeup transmission to the wakeup radios of the group of stations, the second wakeup transmission including an indication that the second wakeup transmission is a retransmission of the first wakeup transmission.

An apparatus for wireless communication is described. The apparatus may include means for transmitting a first wakeup transmission to wakeup radios of a group of stations, means for determining to retransmit the first wakeup transmission to the group of stations, and means for transmitting a second wakeup transmission to the wakeup radios of the group of stations, the second wakeup transmission including an indication that the second wakeup transmission is a retransmission of the first wakeup transmission.

Another apparatus for wireless communication is described. The apparatus may include a processor, memory in electronic communication with the processor, and instructions stored in the memory. The instructions may be operable to cause the processor to transmit a first wakeup transmission to wakeup radios of a group of stations, determine to retransmit the first wakeup transmission to the group of stations, and transmit a second wakeup transmission to the wakeup radios of the group of stations, the second wakeup transmission including an indication that the second wakeup transmission is a retransmission of the first wakeup transmission.

A non-transitory computer readable medium for wireless communication is described. The non-transitory computer-readable medium may include instructions operable to cause a processor to transmit a first wakeup transmission to wakeup radios of a group of stations, determine to retransmit the first wakeup transmission to the group of stations, and transmit a second wakeup transmission to the wakeup radios of the group of stations, the second wakeup transmission including an indication that the second wakeup transmission is a retransmission of the first wakeup transmission.

In some examples of the method, apparatus, and non-transitory computer-readable medium described above, the indication that the second wakeup transmission may be the retransmission of the first wakeup transmission comprises a sequence number. In some examples of the method, apparatus, and non-transitory computer-readable medium described above, the sequence number is included in a type dependent control field of the first wakeup transmission.

Some examples of the method, apparatus, and non-transitory computer-readable medium described above may further include processes, features, means, or instructions for scrambling, based at least in part on a first scrambling sequence, at least a portion of the first wakeup transmission prior to transmitting the first wakeup transmission. Some examples of the method, apparatus, and non-transitory computer-readable medium described above may further include processes, features, means, or instructions for scrambling, based at least in part on the first scrambling sequence, at least a portion of the second wakeup transmission prior to transmitting the second wakeup transmission to provide the indication that the second wakeup transmission may be the retransmission of the first wakeup transmission. In some examples of the method, apparatus, and non-transitory computer-readable medium described above, the second wakeup transmission comprises a unicast transmission addressed to a station of the group of stations.

Some examples of the method, apparatus, and non-transitory computer-readable medium described above may further include processes, features, means, or instructions for transmitting an indication of a time window for the first wakeup transmission, wherein the indication includes a periodicity, an offset with regard to a reference point in time, a length of the time window, or some combination thereof. In some examples of the method, apparatus, and non-transitory computer-readable medium described above, the time window is for wakeup transmissions that are broadcast, or multicast, or a combination thereof.

A method of wireless communication is described. The method may include transmitting a first wakeup transmission to wakeup radios of a group of stations, the first wakeup transmission addressed to the group of stations, and the first wakeup transmission indicating to each station of the group of stations to power on a second radio to communicate with the access point, identifying that one or more stations of the group of stations failed to receive the first wakeup transmission, and transmitting a second wakeup transmission to the identified one or more stations, the second wakeup transmission addressed individually to the one or more stations.

An apparatus for wireless communication is described. The apparatus may include means for transmitting a first wakeup transmission to wakeup radios of a group of stations, the first wakeup transmission addressed to the group of stations, and the first wakeup transmission indicating to each station of the group of stations to power on a second radio to communicate with the access point, means for identifying that one or more stations of the group of stations failed to receive the first wakeup transmission, and means for transmitting a second wakeup transmission to the identified one or more stations, the second wakeup transmission addressed individually to the one or more stations.

Another apparatus for wireless communication is described. The apparatus may include a processor, memory in electronic communication with the processor, and instructions stored in the memory. The instructions may be operable to cause the processor to transmit a first wakeup transmission to wakeup radios of a group of stations, the first wakeup transmission addressed to the group of stations, and the first wakeup transmission indicating to each station of the group of stations to power on a second radio to communicate with the access point, identify that one or more stations of the group of stations failed to receive the first wakeup transmission, and transmit a second wakeup transmission to the identified one or more stations, the second wakeup transmission addressed individually to the one or more stations.

A non-transitory computer readable medium for wireless communication is described. The non-transitory computer-readable medium may include instructions operable to cause a processor to transmit a first wakeup transmission to wakeup radios of a group of stations, the first wakeup transmission addressed to the group of stations, and the first wakeup transmission indicating to each station of the group of stations to power on a second radio to communicate with the access point, identify that one or more stations of the group of stations failed to receive the first wakeup transmission, and transmit a second wakeup transmission to the identified one or more stations, the second wakeup transmission addressed individually to the one or more stations.

In some examples of the method, apparatus, and non-transitory computer-readable medium described above, the second wakeup transmission is a retransmission of the first wakeup transmission. In some examples of the method, apparatus, and non-transitory computer-readable medium described above, the second wakeup transmission addressed individually to the one or more stations comprises a unicast transmission or a multicast transmission. Some examples of the method, apparatus, and non-transitory computer-readable medium described above may further include processes, features, means, or instructions for transmitting an indication of a time window for the first wakeup transmission.

### BRIEF DESCRIPTION OF THE DRAWINGS

FIG. 1 illustrates an example of a system for wireless communication that supports efficient retransmissions for wakeup radios (WUR) in accordance with aspects of the present disclosure.

FIG. 2 illustrates an example of a wireless communications system that supports efficient retransmissions for WUR in accordance with aspects of the present disclosure.

FIG. 3 illustrates an example of a transmission timeline that supports efficient retransmissions for WUR in accordance with aspects of the present disclosure.

FIG. 4 illustrates an example of a process flow that supports efficient retransmissions for WUR in accordance with aspects of the present disclosure.

FIG. 5 illustrates an example of a process flow that supports efficient retransmissions for WUR in accordance with aspects of the present disclosure.

FIGS. 6 through 8 show block diagrams of a device that supports efficient retransmissions for WUR in accordance with aspects of the present disclosure.

FIG. 9 illustrates a block diagram of a system including a station (STA) that supports efficient retransmissions for WUR in accordance with aspects of the present disclosure.

FIGS. 10 through 12 show block diagrams of a device that supports efficient retransmissions for WUR in accordance with aspects of the present disclosure.

FIG. 13 illustrates a block diagram of a system including an access point (AP) that supports efficient retransmissions for WUR in accordance with aspects of the present disclosure.

FIGS. 14 through 17 illustrate methods for efficient retransmissions for WUR in accordance with aspects of the present disclosure.

### DETAILED DESCRIPTION

In some wireless communication systems, wireless devices (e.g., wireless stations (STAs)) may be configured to communicate with an access point (AP) using a main radio and a wakeup radio (WUR). According to techniques described herein, an AP may send (e.g., broadcast or groupcast (transmit to a group of STAs), or otherwise multicast) paging transmissions to a WUR (e.g., specifically a wakeup receiver) of one or more STAs, indicating that the AP has some data to transmit via the main radio to the STAs. That is, STAs may monitor for wakeup messages (e.g., paging messages) using a WUR (e.g., a wakeup receiver), and the wakeup messages may indicate the presence of a beacon to be received via the main radio of the STA. As such, the STA may receive a wakeup message and, in response, wake or power on a main radio for subsequent reception of a beacon transmission. However, for broadcast or multicast wakeup messages, information may be intended for multiple STAs (e.g., a group of STAs), that may be sent more than once (e.g., wakeup or paging messages may be retransmitted by an AP). In such cases, a STA may receive a retransmitted wakeup message (e.g., a duplicate of a wakeup message previously received, or a wakeup message conveying substantially the same information for one or more STAs) and may unnecessarily consume power to transition to the main radio to receive information (e.g., a beacon transmission) that the STA has already received.

According to techniques described here, wireless communications systems may implement wakeup message sequence control to reduce unnecessary power consumption by STAs that may be associated with duplicate wakeup message retransmissions. APs may transmit multicast wakeup messages addressing multiple STAs, and each wakeup message may include a sequence number (e.g., such that the receiving STAs may, in some cases, identify retransmissions). For example, an AP may address STAs via a group ID (GID) in an address field of the wakeup message, for example in a media access control (MAC) header. APs may further include a retransmission indication in retransmitted wakeup messages (e.g., add a retransmission indication signal field to wakeup messages, include sequence number in wakeup messages, etc.), such that STAs that have already received a beacon associated with a wakeup message may not wakeup to receive a duplicate wakeup message. That is, STAs may avoid waking up unnecessarily to receive redundant information (e.g., associated with retransmitted wakeup messages), reducing power consumption.

Aspects of the disclosure are initially described in the context of a wireless communications system. A transmission timeline and process flows supporting discussed techniques are then described. Aspects of the disclosure are further illustrated by and described with reference to apparatus diagrams, system diagrams, and flowcharts that relate to efficient retransmissions for WUR.

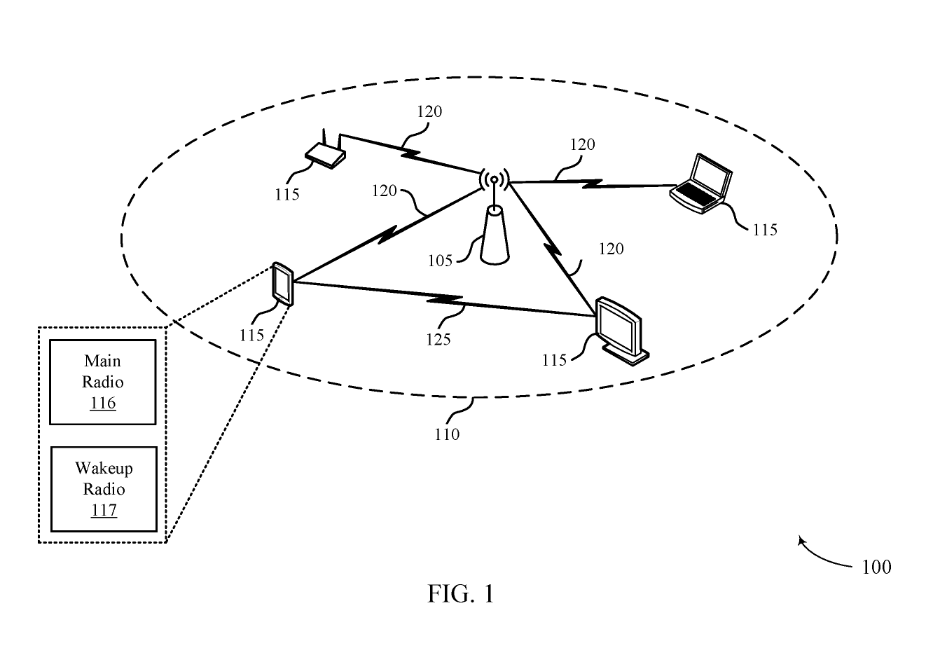

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as wireless communication terminals, including mobile stations, phones personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS. WLAN 100 may support media access control for wakeup radio.

A STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc.

In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands, such as shared licensed frequency bands, where multiple operators may have a license to operate in the same or overlapping frequency band or bands.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

A STA 115 may include a main radio 116 and a low-power WUR 117 for communication. The main radio 116 may be used during active modes (e.g., full power modes) or for high-data throughput applications. A low-power WUR 117 may be used during low-power modes or for low-throughput applications. In some examples, the low-power WUR 117 may be a WUR or a wakeup receiver radio. In some examples, the WUR 117 of a STA 115 may include a wakeup receiver of a WUR, but not include components to transmit wakeup signals for a WUR, such as a wakeup transmitter. In other examples, STA 115 may include both a wakeup receiver and a wakeup transmitter. In some examples, AP 105 may include a wakeup transmitter of a WUR, but not include components to receive wakeup signals for a WUR, such as using a wakeup receiver. In other examples, AP 105 may include both a wakeup receiver and a wakeup transmitter. As used herein, receiving by a WUR or a wakeup receiver refers to a wireless device (e.g., a STA 115, AP 105, or another wireless device) receiving by a wakeup receiver, regardless of the presence or absence of a wakeup transmitter. Likewise, transmitting by a WUR or a wakeup transmitter refers to a wireless device (e.g., a STA 115, AP 105, or another wireless device) transmitting by a wakeup transmitter, regardless of the presence or absence of a wakeup receiver. In some case, the wakeup transmitter of a WUR of a transmitting wireless device (e.g., an AP 105) may be incorporated with or share components with another radio of the AP 105. For example, the AP 105 may use a primary radio of the AP 105 to communicate with a primary radio (e.g., primary communication radio or main radio) of STA 115, and also use the primary radio to transmit wakeup signals to the wakeup receiver of STA 115.

A STA 115 may listen using a WUR, such as WUR 117, for a wakeup message or wakeup frame (e.g., a WUR frame) in a wakeup waveform. Wakeup transmissions described herein may refer to transmissions that include both wakeup signals and auxiliary signals. In some cases, STA 115 may receive a preamble having a first frequency band (e.g., wideband, such as on a 20 MHz channel) and a wakeup signal (e.g., a WUR signal) having a second frequency band (e.g., narrowband, such as a 4-5 MHz channel within the 20 MHz channel). Further, the WUR 117 may share the same medium (e.g., frequency spectrum targeted for reception) as main radio 116. However, transmissions intended for WUR 117 may be associated with lower data rates (e.g., tens or hundreds of kbps).

WLAN 100 may implement wakeup message sequence control to reduce unnecessary power consumption by STAs 115 that may be associated with duplicate wakeup message retransmissions. APs 105 may include a retransmission indication in retransmitted wakeup messages, such that STAs 115 that have already received a beacon associated with a wakeup message may not wakeup to receive a duplicate wakeup message. That is, STAs 115 may avoid waking up unnecessarily to receive redundant information (e.g., associated with retransmitted wakeup messages), reducing power consumption.

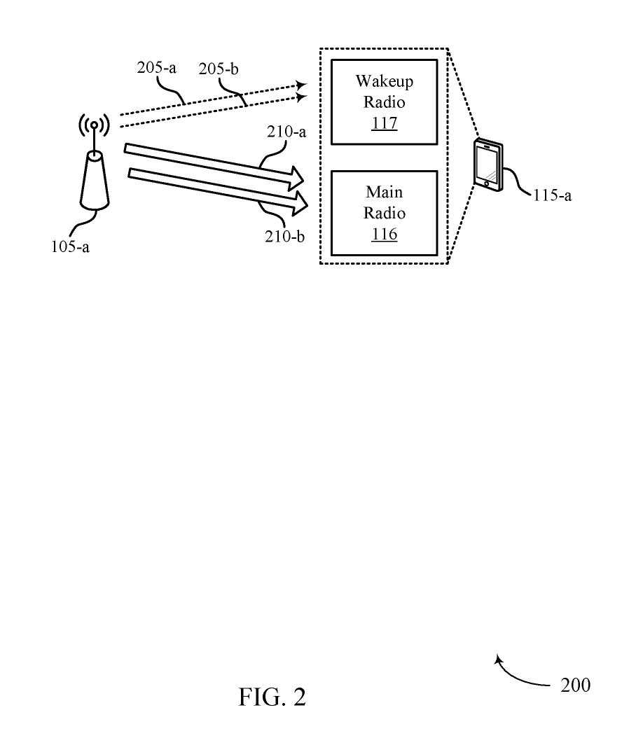

FIG. 2 illustrates an example of a wireless communications system 200 that supports efficient retransmissions for WUR in accordance with various aspects of the present disclosure. Wireless communications system 200 may include an AP 105-a and a STA 115-a which may be examples of the corresponding devices described with reference to FIG. 1. STA 115-a may include a main radio 116 and a WUR 117 for communication. Wireless communications system 200 may illustrate techniques and designs of paging wakeup frames (e.g., wakeup messages 205) for more efficient retransmissions of beacons 210 (e.g., paging beacons).

The main radio 116 may be used during active modes or for high-data throughput applications (e.g., for full power transmissions from AP 105-a). The low-power WUR 117 may be used during low-power modes or for low-throughput applications (e.g., for wakeup transmissions, such as wakeup messages 205, from AP 105-a). A STA 115 may receive a wakeup signal included in wakeup transmissions and power additional circuitry (e.g., main radio 116). In some examples, the low-power WUR 117 may be a WUR. The WUR 117 may listen for wakeup transmissions (e.g., WUR transmissions) from AP 105-a. Upon receiving a wakeup transmission, including a wakeup message 205 for the STA 115-a, the WUR 117 may wakeup the main radio 116 of STA 115-a for primary communications (e.g., full power, high-data throughput applications).

In some cases, AP 105-a may send (e.g., multicast, broadcast, or groupcast, or send to a group of STAs) paging transmissions to a WUR of one or more STAs, indicating that the AP has some data to transmit via the main radio to the STAs. For example, AP 105-a may broadcast or groupcast wakeup messages 205 to a group of STAs to indicate (e.g., via a beacon 210) the AP 105-a is changing a serving channel (e.g., of the WUR and/or main radio), such that all served STAs may need to adjust communications accordingly. According to techniques described herein, the AP may modify a wakeup frame (e.g., a wakeup message 205) to include information indicative of wakeup message retransmissions (e.g., a sequence number, retransmission indication, etc.). Whether or not to use a retransmission indication or a sequence number may depend on the redundancy or number of retransmissions the AP 105-a intends to utilize (e.g., the decision may depend on which will be associated with fewer bits in the wakeup message 205). The AP 105-a may include a sequence number in the wakeup frame (or WUR frame) format (e.g., in the type dependent (TD) control field of a MAC header) for such broadcast or multicast wakeup messages. It should be noted that the present disclosure may be implemented in constant length or variable length WUR frames (e.g., wakeup frames)

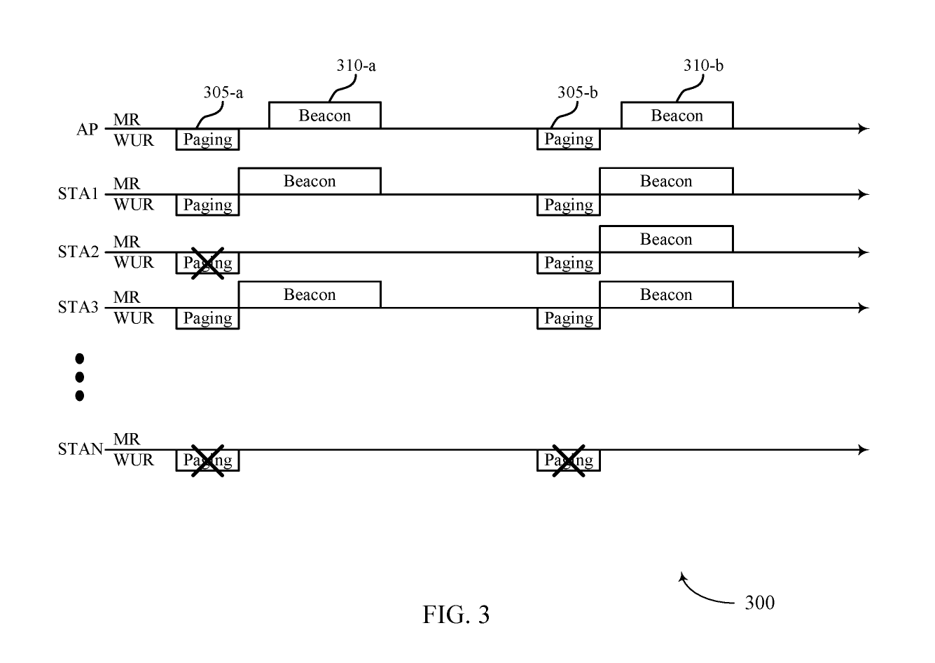

AP 105-a may transmit wakeup message 205-a, determine to retransmit the wakeup message, and transmit wakeup message 205-b. AP 105-a may transmit beacon 210-a after transmitting wakeup message 205-a. Wakeup message 205-b may include such information indicative of wakeup message retransmissions, such that STA 115-a may determine whether to power on main radio 116 to receive beacon 210-b, as further discussed below with reference to FIG. 3.

In some cases, wakeup messages 205 may be encoded or scrambled (e.g., based on a linear-feedback shift register (LFSR) value). If the corresponding scrambling sequence does not match a first value associated with a STA, the STA may determine the wakeup message is current (e.g., not a retransmission). If the LFSR value used by the STA to descramble the wakeup message 205 is the same as the LF SR value used by the STA to descramble a previously received wakeup message 205, the STA may determine the wakeup message 205 is a retransmission. That is, where the LFSR value has not advanced (e.g., the value is frozen for retransmissions). Put differently, the scrambling sequence from an LF SR may advance for new transmissions, but not for retransmissions, such that a receiving STA may determine a retransmission by determining that a sequence used for successful descrambling of a first wakeup message 205 has not changed for a second wakeup message 205. The STA may attempt the next descrambling sequence, and if it fails, try a previously successful sequence. Scrambling of the wakeup message may be used for other purposes, for example to improve security or peak power optimization, and may be used for a limited time window to indicate a retransmitted wakeup message.

In some cases, AP 105-a may specify time windows for broadcast or multicast of such wakeup frames or wakeup messages. For example, the time window may be specified in terms of periodicity, offset with regard to a reference point in time, length of the time window, etc., corresponding to a duty cycle. For example, time windows for receiving broadcast, multicast, or both, may be identified and indicated by AP 105-a to a STA 115-a.

FIG. 3 illustrates an example of a transmission timeline 300 that supports techniques for efficient retransmissions for WUR in accordance with various aspects of the present disclosure. In some cases the transmission timeline 300 may illustrate techniques and designs of wakeup messages 305 for more efficient retransmissions of beacons 310 described with reference to FIGS. 1 and 2. Specifically, transmission timeline 300 illustrates an example AP 105 transmission of wakeup messages 305 (e.g., paging transmissions) and beacons 310, as well as examples of STAs 115 (e.g., STA 1, STA 2, STA 3, and STA N) behavior in the presence of such signaling.

In some cases, the AP may broadcast wakeup messages 305 to a WUR of one or more STAs, indicating that the AP has some data to transmit via the main radio to the STAs. For example, the AP 105 may broadcast or groupcast wakeup messages to a group of STA 1, STA 2, STA 3, STAN, etc. to indicate the AP is changing a serving channel (e.g., of the WUR or main radio), such that all served STAs may need to adjust communications accordingly. The AP may indicate such information via beacons 310. That is, the AP may broadcast or groupcast duplicate wakeup messages (e.g., wakeup message 305-a and wakeup message 305-b), such that served STAs may receive a wakeup message 305, power a main radio, and receive a notification (e.g., a beacon 310) that indicates broadcast information, such as a channel change as discussed above. In some cases, such duplicate wakeup messages (e.g., retransmissions) may be utilized in case some STAs fail to receive one or more wakeup messages due to, for example, packet collisions (e.g., if a STA fails to receive wakeup message 305-a, it may receive wakeup message 305-b). In some cases, wakeup message 305-b may refer to a retransmission of wakeup message 305-a.

In some cases, a wakeup message 305 may be associated with a beacon 310 that indicates some information, and the wakeup message 305 may be broadcast or groupcast multiple times to ensure successful indication of such information to the multiple STAs. However, from the perspective of each STA, only one correctly received beacon 310 may be sufficient to obtain such information. Additional beacons 310 may only include redundant information. The present example illustrates such a scenario via STA 1 and STA 3. STA 1 and STA 3 may successfully receive wakeup message 305-a and may then receive beacon 310-a indicating some information. Further, STA 1 and STA 3 may successfully receive wakeup message 305-b and may then receive beacon 310-b indicating the same redundant information. STA 1 and STA 3 may thus unnecessarily consume power to activate the main radio to receive beacon 310-b.

However, in other cases (e.g., the scenario illustrated for STA 2 and STA N), wakeup message 305-a may be unsuccessfully received (e.g., reception may fail due to collisions, reception errors, etc.). Therefore, STA 2 and STA N may not power a main radio and may not receive beacon 310-a, meaning they may not receive the information broadcast or groupcast by the AP. AP may utilize retransmissions (e.g., redundancy) for such scenarios. The AP may retransmit the wakeup message (e.g., wakeup message 305-b) and retransmit the information in a beacon (e.g., beacon 310-b). STA 2 may then receive the wakeup message 305-b and activate a main radio to receive beacon 310-b, thus ultimately receiving the information broadcast by the AP. A single retransmission is illustrated for simplicity, techniques described herein may be applied to any number of retransmissions by analogy, without departing from the scope of the disclosure. For example, STA N may also fail to receive the wakeup message 305-b. However, STA N may receive a duplicate wakeup transmission later transmitted by the AP.

Therefore, according to techniques described herein, the AP may include a sequence number or an indication of a retransmission in duplicate paging transmissions or frames (e.g., wakeup message 305-b may include a sequence number or indication indicative of wakeup message 305-b being a retransmission of wakeup message 305-a). In such cases, when STA 1 and STA 3 receive wakeup message 305-b, STA 1 and STA 3 may determine the wakeup message 305-b is a retransmission of wakeup message 305-a, which is associated with information already received (e.g., via beacon 310-a). Such methods may reduce unnecessary power consumption associated with STA 1 and STA 3 powering a main radio for redundant information.

Additionally or alternatively, STAs that have missed a wakeup message (e.g., STA 2 misses wakeup message 305-a), may use the sequence number, or indication of a retransmission to determine a previous wakeup message and/or associated beacon information has been missed. In some cases, indication of a retransmission may use fewer bits than a sequence number, depending on the number of retransmissions utilized by the AP. The STA may subsequently power the main radio to receive the beacon and obtain the associated information. That is, STA 2 may determine wakeup message 305-b is a retransmission, but may also determine the original transmission (e.g., wakeup message 305-a) was not received. STA 2 may then power the main radio, and receive the new information via beacon 310-b.

In other cases, the AP may identify the STAs that failed to receive wakeup message 305-a, and thus beacon 310-a, and transmit wakeup message 305-b individually addressed (e.g., by a WUR ID (WID) in a MAC header address field) to each STA (e.g., individually address, via a unicast transmission, wakeup message 305-b to STA 2 and STA N). For example, the AP may receive beacon acknowledgements from some STAs (e.g., via a primary connectivity radio (PCR)), and may convert wakeup messages (e.g., wakeup message 305-b) to unicast towards STAs that did not transmit a beacon acknowledgment. Alternatively, the AP may continue to transmit wakeup message 305-b via groupcast or broadcast, which may prevent undesirable overhead associated with sending wakeup messages individually addressed to each STA that did not transmit a beacon acknowledgement. That is, the determination of whether to groupcast or broadcast wakeup messages may depend on the number of STAs that failed to receive wakeup message (e.g., wakeup message retransmissions may be groupcast or broadcast in scenarios where a relatively large number of STAs failed to receive the wakeup message, and wakeup message retransmissions may be unicast or may address each STA individually in cases where relatively few STAs failed to receive the wakeup message).

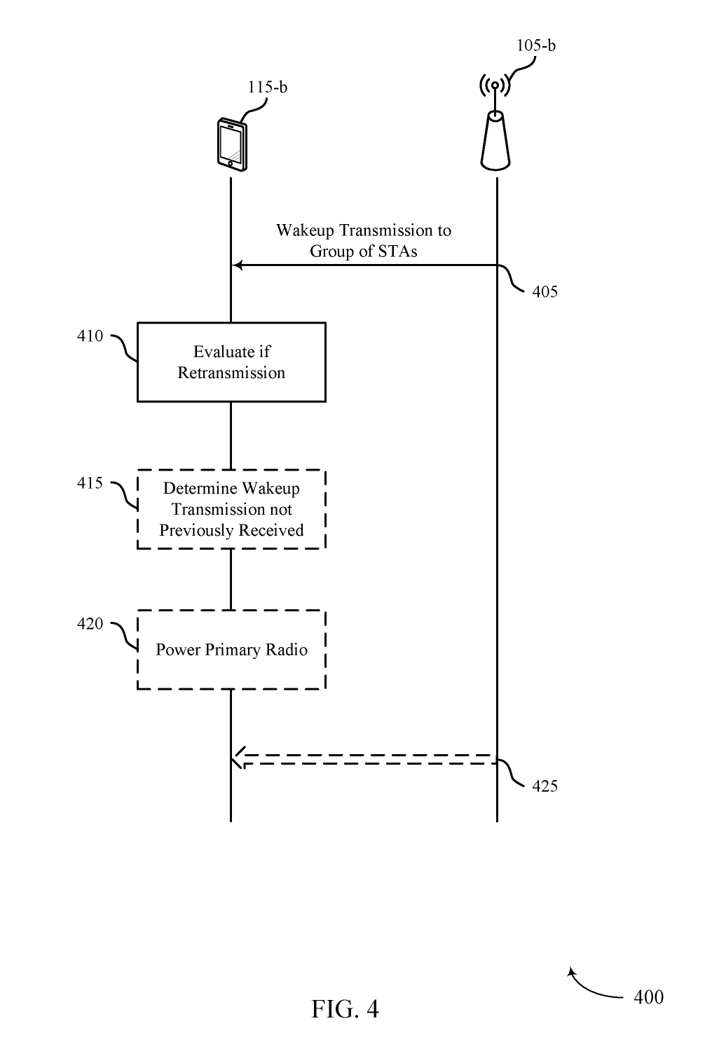

FIG. 4 illustrates an example of a process flow 400 that supports efficient retransmissions for WUR in accordance with various aspects of the present disclosure. Process flow 400 may include AP 105-c, AP 105-d, and STA 115-b, which may represent aspects of techniques performed by a STA 115 or AP 105 as described with reference to FIGS. 1-3.

At step 405, AP 105-b may transmit a wakeup transmission (e.g., a wakeup message) to WURs of a group of STAs (e.g., including STA 115-b). In some cases, the wakeup transmission may include an indication (e.g., a sequence number or retransmission indication signal field) that the wakeup transmission is a retransmission of a first wakeup transmission. In some cases, AP 105-a may transmit an indication of a time window for the first wakeup transmission prior to step 405, where the indication includes a periodicity, an offset with regard to a reference point in time, and/or a length of the time window.

At step 410, STA 115-b may evaluate the wakeup transmission received at step 405. In some cases, the STA 115-b may identify a successful descrambling sequence of one or more candidate descrambling sequences and determine that the received wakeup transmission is the retransmission of a prior wakeup transmission based at least in part on the identified successful descrambling sequence. Alternatively, the STA 115-b may determine the wakeup transmission is not a retransmission, or that the wakeup transmission is a retransmission of a wakeup transmission that has not been previously received by the STA 115-b.

If the wakeup transmission evaluated at step 410 is determined to be a retransmission of a wakeup message that was previously transmitted by AP 105-b, the STA 115-b may proceed to step 415. At step 415, STA 115-b may determine if the wakeup transmission received at step 405 (e.g., that has previously been transmitted by AP 105-b) has previously been received. That is, the STA 115-b may determine the received wakeup message has been previously received, in which case the STA 115-b may not power the main radio, and may resume WUR operation until the next paging period or until the next wakeup message is received. Alternatively, the STA 115-b may determine, even though the wakeup essage is a retransmission from AP 105-b, the wakeup message has not been previously received (e.g., due to a reception failure associated with the previous transmission of the wakeup message).

In cases where STA 115-b determined (e.g., at step 410) the wakeup transmission received at step 405 has not been previously received (e.g., is a retransmission from AP 105-b, but has not been previously received by STA 115-b), the STA 115-b may proceed through steps 420 and 425.

At step 420, STA 115-b may power a main radio based on not having previously received the beacon associated with the wakeup message received at step 405.

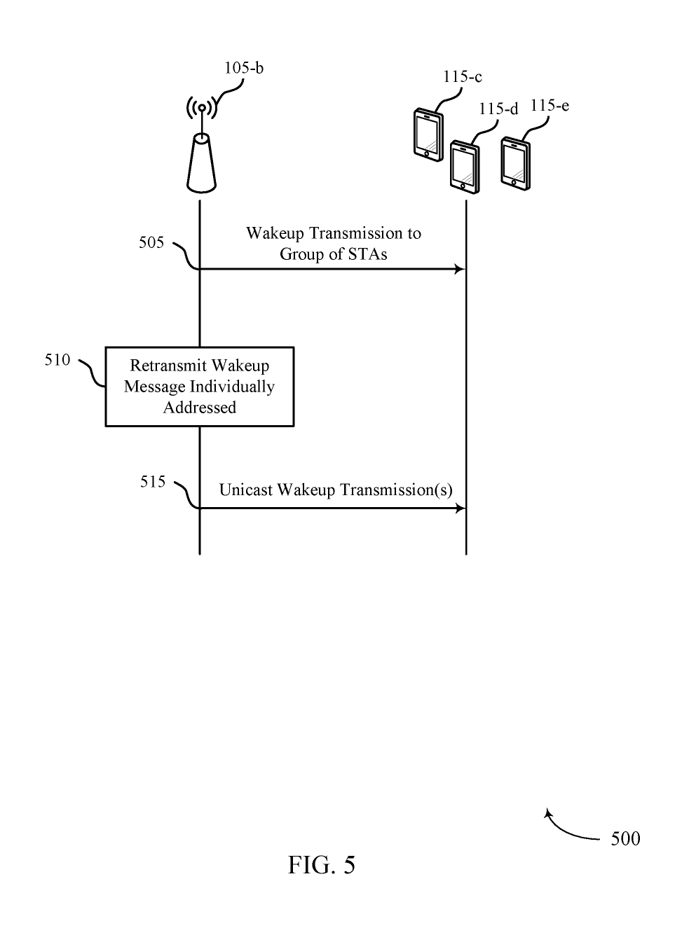

FIG. 5 illustrates an example of a process flow 500 that supports efficient retransmissions for WUR in accordance with various aspects of the present disclosure. Process flow 500 may include AP 105-c, AP 105-d, and STA 115-b, which may represent aspects of techniques performed by a STA 115 or AP 105 as described with reference to FIGS. 1-3.

At step 505, AP 105-b may transmit a first wakeup transmission to wakeup radios of a group of stations (e.g., STA 115-c, STA 115-d, STA 115-e), the first wakeup transmission addressed to the group of stations (e.g., broadcast or multicast), and the first wakeup transmission indicating to each station of the group of stations to power on a second radio to communicate with the access point.

At step 510, AP 105-b may identify that one or more stations of the group of stations failed to receive the first wakeup transmission. Such identification may include, for instance, AP 105-b not receiving beacon acknowledgment messages from one, some, or all of the group of stations (e.g., STA 115-c, STA 115-d, STA 115-e).

At step 515, AP 105-b may transmit a second wakeup transmission to the identified one or more stations, the second wakeup transmission addressed individually (e.g., via a WID in a MAC header Address field) to the one or more stations (e.g., the second wakeup transmission may include individual unicast wakeup transmissions to each of STA 115-c, STA 115-d, STA 115-e).

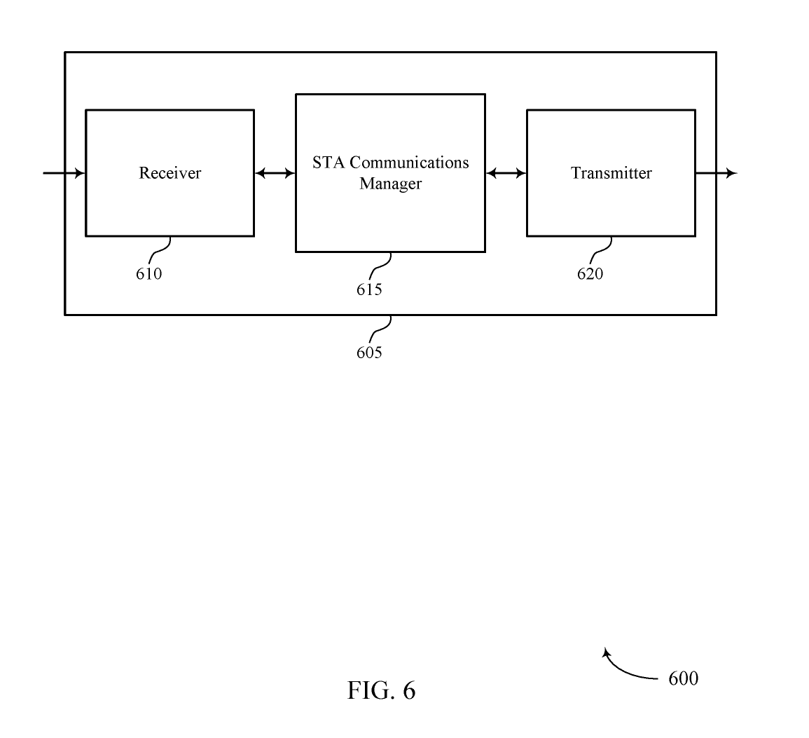

FIG. 6 shows a block diagram 600 of a wireless device 605 that supports efficient retransmissions for WUR in accordance with aspects of the present disclosure. Wireless device 605 may be an example of aspects of a station (STA) 115 as described herein. Wireless device 605 may include receiver 610, STA communications manager 615, and transmitter 620. Wireless device 605 may also include a processor. Each of these components may be in communication with one another (e.g., via one or more buses).

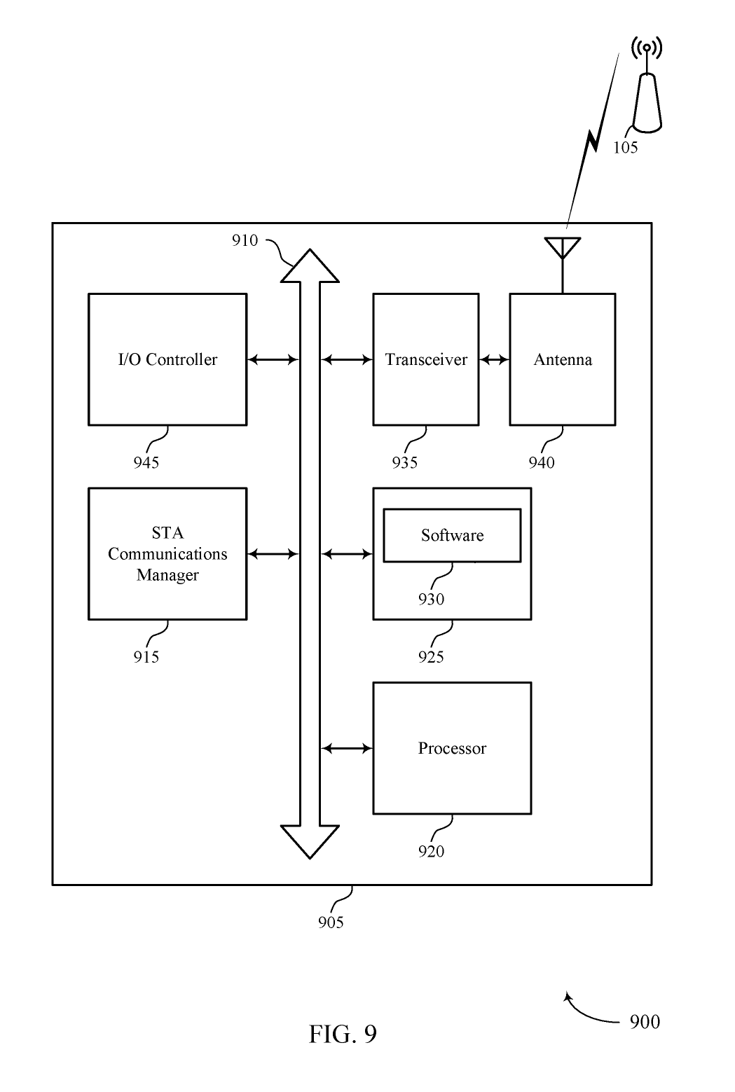

Receiver 610 may receive information such as packets, user data, or control information associated with various information channels (e.g., control channels, data channels, and information related to efficient retransmissions for WUR, etc.). Information may be passed on to other components of the device. The receiver 610 may be an example of aspects of the transceiver 935 described with reference to FIG. 9. The receiver 610 may utilize a single antenna or a set of antennas.

STA communications manager 615 may be an example of aspects of the STA communications manager 915 described with reference to FIG. 9. STA communications manager 615 and/or at least some of its various sub-components may be implemented in hardware, software executed by a processor, firmware, or any combination thereof. If implemented in software executed by a processor, the functions of the STA communications manager 615 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The STA communications manager 615 and/or at least some of its various sub-components may be physically located at various positions, including being distributed such that portions of functions are implemented at different physical locations by one or more physical devices. In some examples, STA communications manager 615 and/or at least some of its various sub-components may be a separate and distinct component in accordance with various aspects of the present disclosure. In other examples, STA communications manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

STA communications manager 615 may receive, at a wakeup radio of a station, a first wakeup transmission addressed to a group of stations that includes the station. The first wakeup transmission may indicate to the station to power on a second radio of the station to communicate with an access point and identify that the first wakeup transmission is a retransmission of a prior wakeup transmission for the group of stations based on an indication included in the first wakeup transmission.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may utilize a single antenna or a set of antennas.

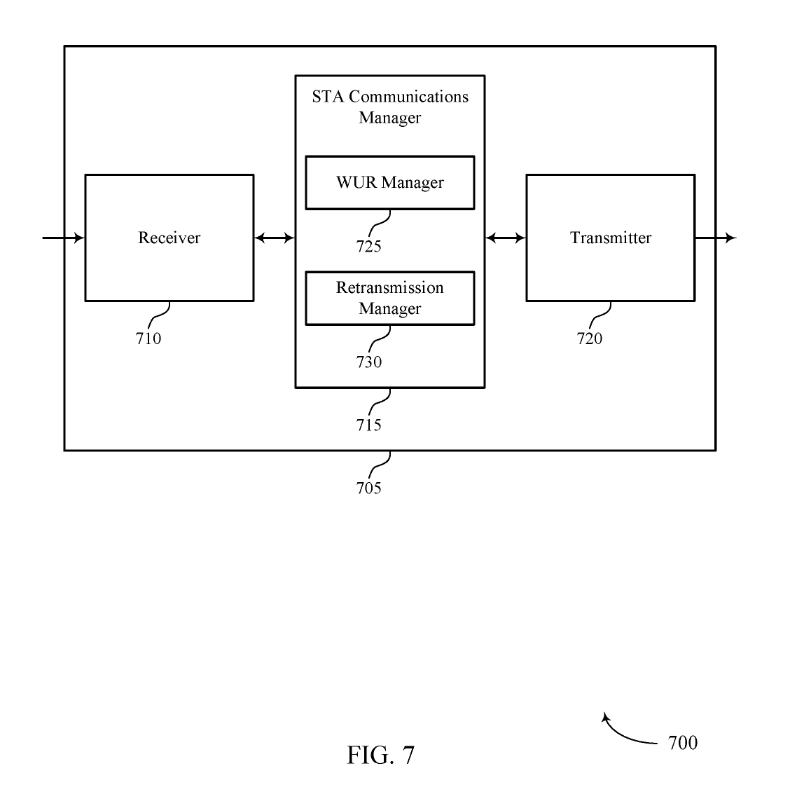

FIG. 7 shows a block diagram 700 of a wireless device 705 that supports efficient retransmissions for WUR in accordance with aspects of the present disclosure. Wireless device 705 may be an example of aspects of a wireless device 605 or a STA 115 as described with reference to FIG. 6. Wireless device 705 may include receiver 710, STA communications manager 715, and transmitter 720. Wireless device 705 may also include a processor. Each of these components may be in communication with one another (e.g., via one or more buses).

Receiver 710 may receive information such as packets, user data, or control information associated with various information channels (e.g., control channels, data channels, and information related to efficient retransmissions for WUR, etc.). Information may be passed on to other components of the device. The receiver 710 may be an example of aspects of the transceiver 935 described with reference to FIG. 9. The receiver 710 may utilize a single antenna or a set of antennas.

STA communications manager 715 may be an example of aspects of the STA communications manager 915 described with reference to FIG. 9. STA communications manager 715 may also include WUR manager 725 and retransmission manager 730.

WUR manager 725 may receive, at the wakeup radio of the station, the prior wakeup transmission and receive, at a wakeup radio of a station, a first wakeup transmission addressed to a group of stations that includes the station. The first wakeup transmission may indicate to the station to power on a second radio of the station to communicate with an access point. In some cases, the first wakeup transmission is scrambled based on a scrambling sequence. In some cases, identifying that the first wakeup transmission is the retransmission of the prior wakeup transmission for the group of stations may include identifying a successful descrambling sequence of one or more candidate descrambling sequences.

Retransmission manager 730 may identify that the first wakeup transmission is a retransmission of a prior wakeup transmission for the group of stations based on an indication included in the first wakeup transmission, determine that the station failed to receive the prior wakeup transmission, and determine that the first wakeup transmission is the retransmission of the prior wakeup transmission based on the identified successful descrambling sequence. In some cases, the indication that the first wakeup transmission is the retransmission of the prior wakeup transmission includes a first sequence number.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may utilize a single antenna or a set of antennas.

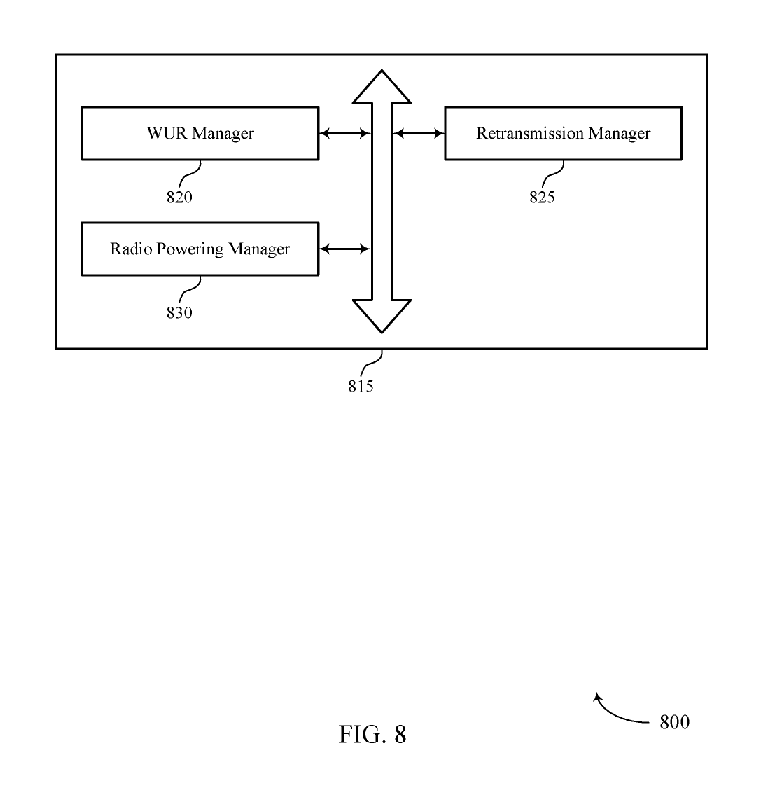

FIG. 8 shows a block diagram 800 of a STA communications manager 815 that supports efficient retransmissions for WUR in accordance with aspects of the present disclosure. The STA communications manager 815 may be an example of aspects of a STA communications manager 615, a STA communications manager 715, or a STA communications manager 915 described with reference to FIGS. 6, 7, and 9. The STA communications manager 815 may include WUR manager 820, retransmission manager 825, and radio powering manager 830. Each of these modules may communicate, directly or indirectly, with one another (e.g., via one or more buses).

WUR manager 820 may receive, at the wakeup radio of the station, the prior wakeup transmission and receive, at a wakeup radio of a station, a first wakeup transmission addressed to a group of stations that includes the station. The first wakeup transmission indicates to the station to power on a second radio of the station to communicate with an access point. In some cases, the first wakeup transmission is scrambled based on a scrambling sequence. In some cases, identifying that the first wakeup transmission is the retransmission of the prior wakeup transmission for the group of stations includes: identifying a successful descrambling sequence of one or more candidate descrambling sequences. In some cases, the first wakeup transmission comprises a unicast transmission addressed to the station. In some cases, WUR manager 820 may receive an indication of a time window for the first wakeup transmission. In some cases, the time window is for wakeup transmissions that are broadcast, or multicast, or a combination thereof. In some cases, the time window comprises a periodicity, an offset from a reference point in time, a length of the time window, or a combination thereof. In some cases, the first wakeup transmission is received in a first time window and the prior wakeup transmission is received in a prior transmission window.

Retransmission manager 825 may identify that the first wakeup transmission is a retransmission of a prior wakeup transmission for the group of stations based on an indication included in the first wakeup transmission, determine that the station failed to receive the prior wakeup transmission, and determine that the first wakeup transmission is the retransmission of the prior wakeup transmission based on the identified successful descrambling sequence. In some cases, the indication that the first wakeup transmission is the retransmission of the prior wakeup transmission includes a first sequence number. In some cases, retransmission manager 825 may compare the first sequence number included in the first wakeup transmission to a second sequence number in the prior wakeup transmission. In some cases, the first sequence number is included in a type dependent control field of the first wakeup transmission. In some cases, retransmission manager 825 may identify that the first wakeup transmission is the retransmission of the prior wakeup transmission for the group of stations by being configured to identify a successful descrambling sequence of one or more candidate descrambling sequences, and determine that the first wakeup transmission is the retransmission of the prior wakeup transmission based at least in part on the identified successful descrambling sequence.

Radio powering manager 830 may power on the second radio of the station to communicate with the access point based on receiving the first wakeup transmission and refrain from powering on the second radio of the station to communicate with the access point in response to the first wakeup transmission. Such refraining may be based on identifying that the first wakeup transmission is a retransmission of a prior wakeup transmission for the group of stations, further based on an indication included in the first wakeup transmission.

FIG. 9 shows a diagram of a system 900 including a device 905 that supports efficient retransmissions for WUR in accordance with aspects of the present disclosure. Device 905 may be an example of or include the components of wireless device 605, wireless device 705, or a STA 115 as described above, e.g., with reference to FIGS. 6 and 7. Device 905 may include components for bi-directional voice and data communications including components for transmitting and receiving communications, including STA communications manager 915, processor 920, memory 925, software 930, transceiver 935, antenna 940, and I/O controller 945. These components may be in electronic communication via one or more buses (e.g., bus 910).

Processor 920 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting efficient retransmissions for WUR).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware or software operation such as the interaction with peripheral components or devices.

Software 930 may include code to implement aspects of the present disclosure, including code to support efficient retransmissions for WURs. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system. In other cases, I/O controller 945 may represent or interact with a modem, a keyboard, a mouse, a touchscreen, or a similar device. In some cases, I/O controller 945 may be implemented as part of a processor. In some cases, a user may interact with device 905 via I/O controller 945 or via hardware components controlled by I/O controller 945.

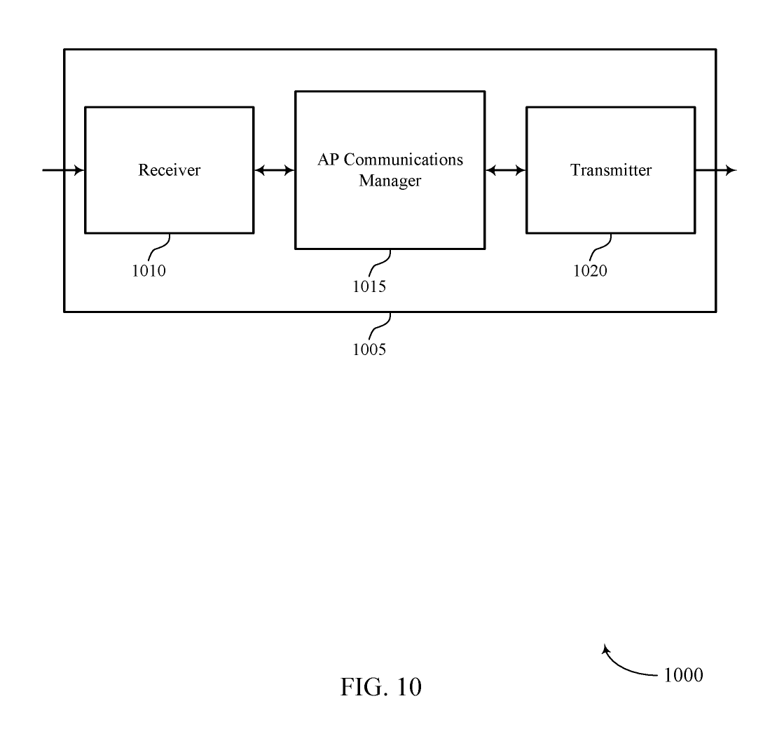

FIG. 10 shows a block diagram 1000 of a wireless device 1005 that supports efficient retransmissions for WUR in accordance with aspects of the present disclosure. Wireless device 1005 may be an example of aspects of an access point (AP) 105 as described herein. Wireless device 1005 may include receiver 1010, AP communications manager 1015, and transmitter 1020. Wireless device 1005 may also include a processor. Each of these components may be in communication with one another (e.g., via one or more buses).

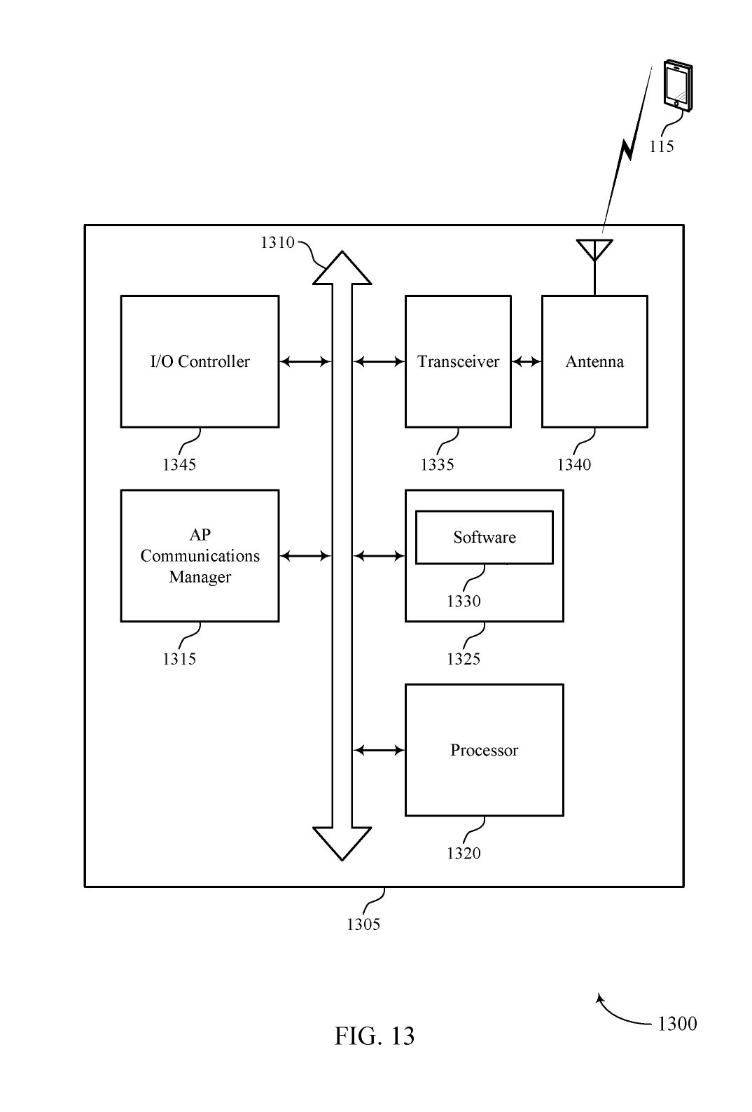

Receiver 1010 may receive information such as packets, user data, or control information associated with various information channels (e.g., control channels, data channels, and information related to efficient retransmissions for WUR, etc.). Information may be passed on to other components of the device. The receiver 1010 may be an example of aspects of the transceiver 1335 described with reference to FIG. 13. The receiver 1010 may utilize a single antenna or a set of antennas.

AP communications manager 1015 may be an example of aspects of the AP communications manager 1315 described with reference to FIG. 13. AP communications manager 1015 and/or at least some of its various sub-components may be implemented in hardware, software executed by a processor, firmware, or any combination thereof. If implemented in software executed by a processor, the functions of the AP communications manager 1015 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The AP communications manager 1015 and/or at least some of its various sub-components may be physically located at various positions, including being distributed such that portions of functions are implemented at different physical locations by one or more physical devices. In some examples, AP communications manager 1015 and/or at least some of its various sub-components may be a separate and distinct component in accordance with various aspects of the present disclosure. In other examples, AP communications manager 1015 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

AP communications manager 1015 may transmit a first wakeup transmission to wakeup radios of a group of stations and determine to retransmit the first wakeup transmission to the group of stations. AP communications manager 1015 may transmit a second wakeup transmission to the wakeup radios of the group of stations, where the second wakeup transmission may include an indication that the second wakeup transmission is a retransmission of the first wakeup transmission. The AP communications manager 1015 may also transmit a first wakeup transmission to wakeup radios of a group of stations. The first wakeup transmission may be addressed to the group of stations, and may indicate to each station of the group of stations to power on a second radio to communicate with the access point. The AP communications manager 1015 may identify that one or more stations of the group of stations failed to receive the first wakeup transmission, and transmit a second wakeup transmission to the identified one or more stations. In some cases, the second wakeup transmission may be addressed individually to the one or more stations.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1335 described with reference to FIG. 13. The transmitter 1020 may utilize a single antenna or a set of antennas.

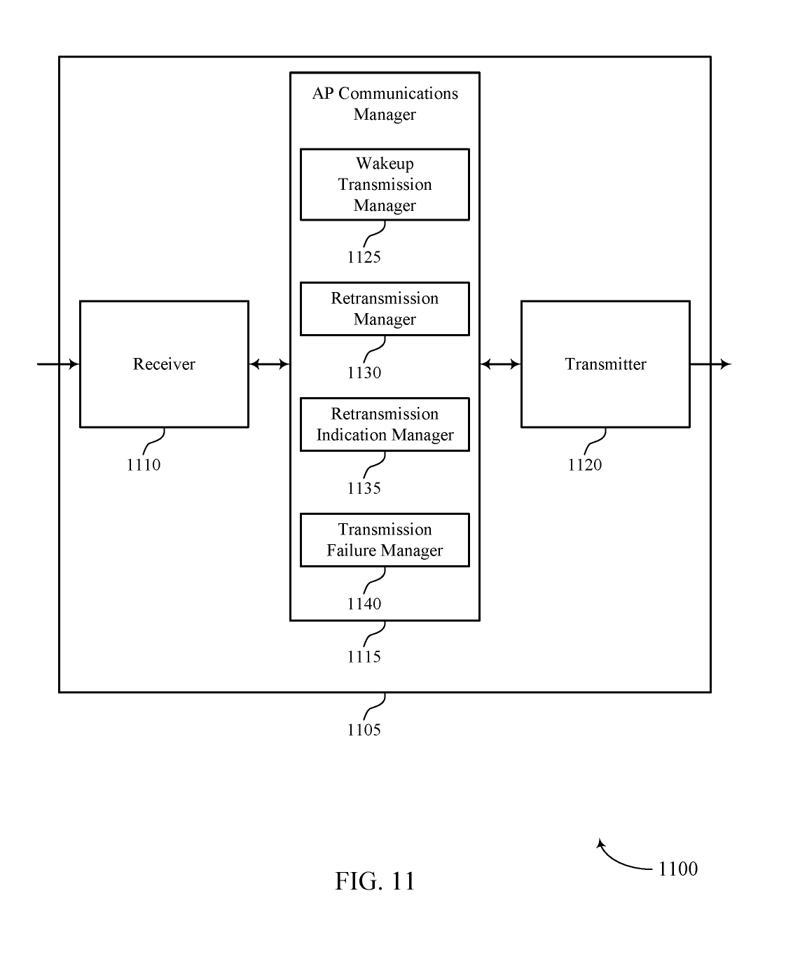

FIG. 11 shows a block diagram 1100 of a wireless device 1105 that supports efficient retransmissions for WUR in accordance with aspects of the present disclosure. Wireless device 1105 may be an example of aspects of a wireless device 1005 or an AP105 as described with reference to FIG. 10. Wireless device 1105 may include receiver 1110, AP communications manager 1115, and transmitter 1120. Wireless device 1105 may also include a processor. Each of these components may be in communication with one another (e.g., via one or more buses).

Receiver 1110 may receive information such as packets, user data, or control information associated with various information channels (e.g., control channels, data channels, and information related to efficient retransmissions for WUR, etc.). Information may be passed on to other components of the device. The receiver 1110 may be an example of aspects of the transceiver 1335 described with reference to FIG. 13. The receiver 1110 may utilize a single antenna or a set of antennas.

AP communications manager 1115 may be an example of aspects of the AP communications manager 1315 described with reference to FIG. 13. AP communications manager 1115 may also include wakeup transmission manager 1125, retransmission manager 1130, retransmission indication manager 1135, and transmission failure manager 1140.

Wakeup transmission manager 1125 may transmit a first wakeup transmission to wakeup radios of a group of stations and transmit a first wakeup transmission to wakeup radios of a group of stations, where the first wakeup transmission may be addressed to the group of stations, and the first wakeup transmission indicating to each station of the group of stations to power on a second radio to communicate with the access point.

Retransmission manager 1130 may determine to retransmit the first wakeup transmission to the group of stations and transmit a second wakeup transmission to the identified one or more stations, where the second wakeup transmission may be addressed individually to the one or more stations.

Retransmission indication manager 1135 may transmit a second wakeup transmission to the wakeup radios of the group of stations, where the second wakeup transmission may include an indication that the second wakeup transmission is a retransmission of the first wakeup transmission. In some cases, the indication that the second wakeup transmission is the retransmission of the first wakeup transmission may include a sequence number.

Transmission failure manager 1140 may identify that one or more stations of the group of stations failed to receive the first wakeup transmission.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1335 described with reference to FIG. 13. The transmitter 1120 may utilize a single antenna or a set of antennas.

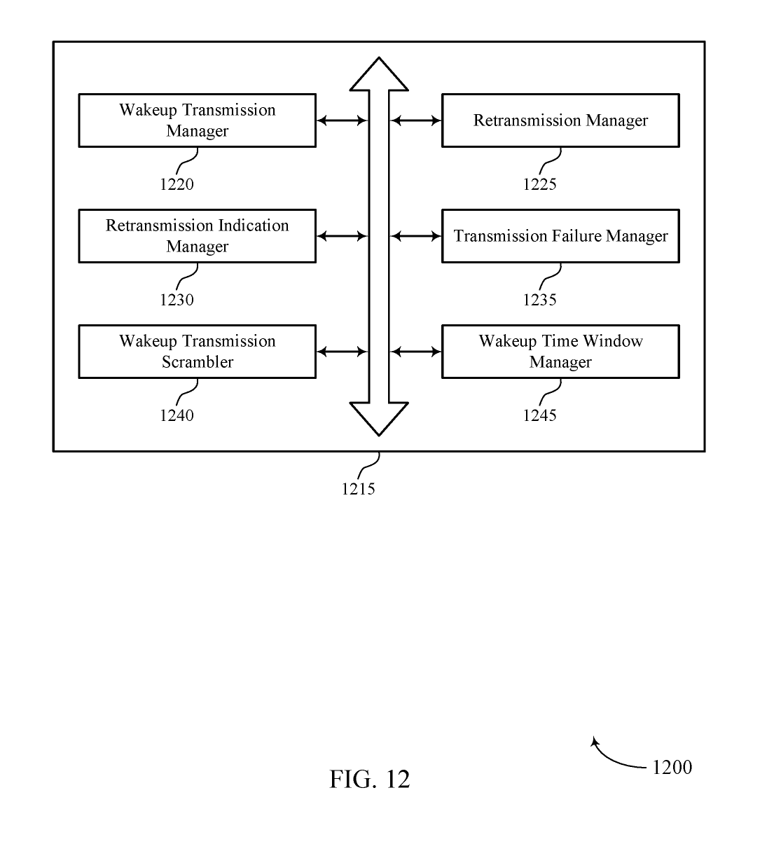

FIG. 12 shows a block diagram 1200 of an AP communications manager 1215 that supports efficient retransmissions for WUR in accordance with aspects of the present disclosure. The AP communications manager 1215 may be an example of aspects of an AP communications manager 1315 described with reference to FIGS. 10, 11, and 13. The AP communications manager 1215 may include wakeup transmission manager 1220, retransmission manager 1225, retransmission indication manager 1230, transmission failure manager 1235, wakeup transmission scrambler 1240, and wakeup time window manager 1245. Each of these modules may communicate, directly or indirectly, with one another (e.g., via one or more buses).

Wakeup transmission manager 1220 may transmit a first wakeup transmission to wakeup radios of a group of stations and transmit a first wakeup transmission to wakeup radios of a group of stations, where the first wakeup transmission may be addressed to the group of stations. In some cases, the first wakeup transmission may indicate to each station of the group of stations to power on a second radio to communicate with the access point.

Retransmission manager 1225 may determine to retransmit the first wakeup transmission to the group of stations and transmit a second wakeup transmission to the identified one or more stations, where the second wakeup transmission may be addressed individually to the one or more stations. In some cases, the second wakeup transmission is a retransmission of the first wakeup transmission. In some cases, the second wakeup transmission addressed individually to the one or more stations comprises a unicast transmission or a multicast transmission. In some cases, retransmission manager 1225 may transmit an indication of a time window for the first wakeup transmission. In some cases, the second wakeup transmission comprises a unicast transmission addressed to a station of the group of stations.

Retransmission indication manager 1230 may transmit a second wakeup transmission to the wakeup radios of the group of stations, where the second wakeup transmission may include an indication that the second wakeup transmission is a retransmission of the first wakeup transmission. In some cases, the indication that the second wakeup transmission is the retransmission of the first wakeup transmission includes a sequence number. In some cases, the sequence number is included in a type dependent control field of the first wakeup transmission.

Transmission failure manager 1235 may identify that one or more stations of the group of stations failed to receive the first wakeup transmission.

Wakeup transmission scrambler 1240 may scramble, based on a first scrambling sequence, at least a portion of the first wakeup transmission prior to transmitting the first wakeup transmission and scramble, based on the first scrambling sequence, at least a portion of the second wakeup transmission prior to transmitting the second wakeup transmission to provide the indication that the second wakeup transmission is the retransmission of the first wakeup transmission.

Wakeup time window manager 1245 may transmit an indication of a time window for the first wakeup transmission, where the indication includes a periodicity, an offset with regard to a reference point in time, a length of the time window, or some combination thereof. In some case, the time window is for wakeup transmissions that are broadcast, or multicast, or a combination thereof

FIG. 13 shows a diagram of a system 1300 including a device 1305 that supports efficient retransmissions for WUR in accordance with aspects of the present disclosure. Device 1305 may be an example of or include the components of AP 105 as described above, e.g., with reference to FIG. 1. Device 1305 may include components for bi-directional voice and data communications including components for transmitting and receiving communications, including AP communications manager 1315, processor 1320, memory 1325, software 1330, transceiver 1335, antenna 1340, and I/O controller 1345. These components may be in electronic communication via one or more buses (e.g., bus 1310).

Processor 1320 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1320 may be configured to operate a memory array using a memory controller. In other cases, a memory controller may be integrated into processor 1320. Processor 1320 may be configured to execute computer-readable instructions stored in a memory to perform various functions (e.g., functions or tasks supporting efficient retransmissions for WUR).

Memory 1325 may include RAM and ROM. The memory 1325 may store computer-readable, computer-executable software 1330 including instructions that, when executed, cause the processor to perform various functions described herein. In some cases, the memory 1325 may contain, among other things, a BIOS which may control basic hardware or software operation such as the interaction with peripheral components or devices.

Software 1330 may include code to implement aspects of the present disclosure, including code to support efficient retransmissions for WURs. Software 1330 may be stored in a non-transitory computer-readable medium such as system memory or other memory. In some cases, the software 1330 may not be directly executable by the processor but may cause a computer (e.g., when compiled and executed) to perform functions described herein.

Transceiver 1335 may communicate bi-directionally, via one or more antennas, wired, or wireless links as described above. For example, the transceiver 1335 may represent a wireless transceiver and may communicate bi-directionally with another wireless transceiver. The transceiver 1335 may also include a modem to modulate the packets and provide the modulated packets to the antennas for transmission, and to demodulate packets received from the antennas.

In some cases, the wireless device may include a single antenna 1340. However, in some cases the device may have more than one antenna 1340, which may be capable of concurrently transmitting or receiving multiple wireless transmissions.

I/O controller 1345 may manage input and output signals for device 1305. I/O controller 1345 may also manage peripherals not integrated into device 1305. In some cases, I/O controller 1345 may represent a physical connection or port to an external peripheral. In some cases, I/O controller 1345 may utilize an operating system such as iOS®, ANDROID®, MS-DOS®, MS-WINDOWS®, OS/2®, UNIX®, LINUX®, or another known operating system. In other cases, I/O controller 1345 may represent or interact with a modem, a keyboard, a mouse, a touchscreen, or a similar device. In some cases, I/O controller 1345 may be implemented as part of a processor. In some cases, a user may interact with device 1305 via I/O controller 1345 or via hardware components controlled by I/O controller 1345.

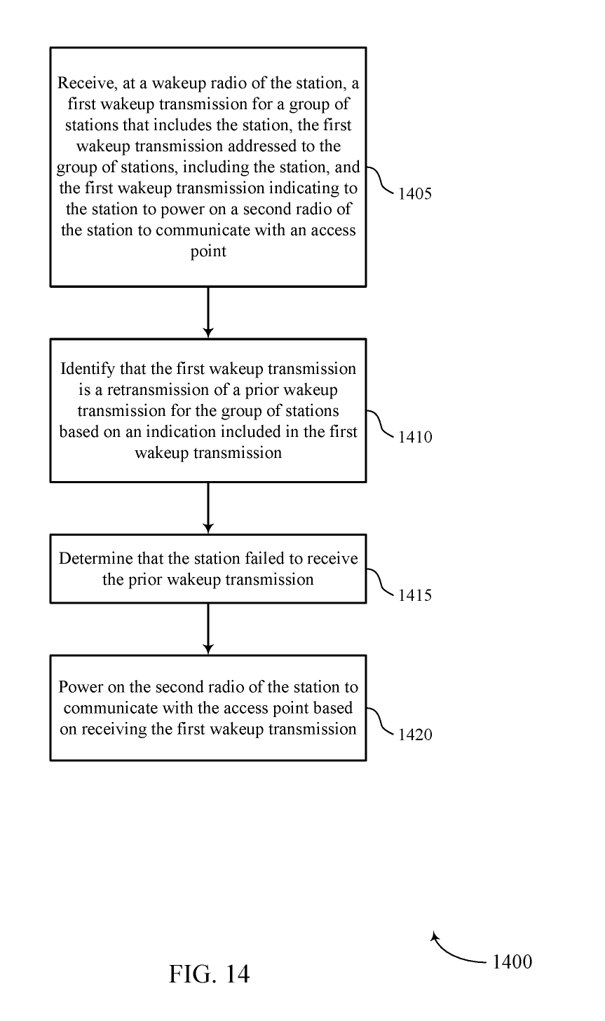

FIG. 14 shows a flowchart illustrating a method 1400 for efficient retransmissions for WUR in accordance with aspects of the present disclosure. The operations of method 1400 may be implemented by a STA 115 or its components as described herein. For example, the operations of method 1400 may be performed by a STA communications manager as described with reference to FIGS. 6 through 9. In some examples, a STA 115 may execute a set of codes to control the functional elements of the device to perform the functions described below. Additionally or alternatively, the STA 115 may perform aspects of the functions described below using special-purpose hardware.

At block 1405 the STA 115 may receive, at a wakeup radio of a station, a first wakeup transmission addressed to a group of stations that includes the station, wherein the first wakeup transmission indicates to the station to power on a second radio of the station to communicate with an access point. The operations of block 1405 may be performed according to the methods described herein. In certain examples, aspects of the operations of block 1405 may be performed by a WUR manager as described with reference to FIGS. 6 through 9.

At block 1410 the STA 115 may identify that the first wakeup transmission is a retransmission of a prior wakeup transmission for the group of stations based at least in part on an indication included in the first wakeup transmission. The operations of block 1410 may be performed according to the methods described herein. In certain examples, aspects of the operations of block 1410 may be performed by a retransmission manager as described with reference to FIGS. 6 through 9.

At block 1415 the STA 115 may determine that the station failed to receive the prior wakeup transmission. The operations of block 1415 may be performed according to the methods described herein. In certain examples, aspects of the operations of block 1415 may be performed by a retransmission manager as described with reference to FIGS. 6 through 9.

At block 1420 the STA 115 may power on the second radio of the station to communicate with the access point based at least in part on receiving the first wakeup transmission. The operations of block 1420 may be performed according to the methods described herein. In certain examples, aspects of the operations of block 1420 may be performed by a radio powering manager as described with reference to FIGS. 6 through 9.

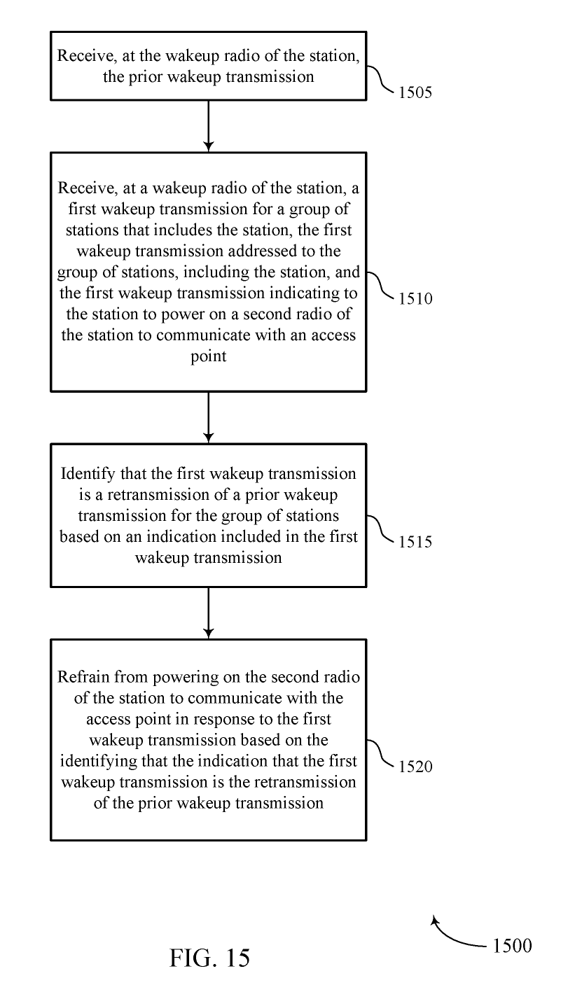

FIG. 15 shows a flowchart illustrating a method 1500 for efficient retransmissions for WUR in accordance with aspects of the present disclosure. The operations of method 1500 may be implemented by a STA 115 or its components as described herein. For example, the operations of method 1500 may be performed by a STA communications manager as described with reference to FIGS. 6 through 9. In some examples, a STA 115 may execute a set of codes to control the functional elements of the device to perform the functions described below. Additionally or alternatively, the STA 115 may perform aspects of the functions described below using special-purpose hardware.

At block 1505 the STA 115 may receive, at the wakeup radio of the station, the prior wakeup transmission. The operations of block 1505 may be performed according to the methods described herein. In certain examples, aspects of the operations of block 1505 may be performed by a WUR manager as described with reference to FIGS. 6 through 9.

At block 1510 the STA 115 may receive, at a wakeup radio of a station, a first wakeup transmission addressed to a group of stations that includes the station, wherein the first wakeup transmission indicates to the station to power on a second radio of the station to communicate with an access point. The operations of block 1510 may be performed according to the methods described herein. In certain examples, aspects of the operations of block 1510 may be performed by a WUR manager as described with reference to FIGS. 6 through 9.

At block 1515 the STA 115 may identify that the first wakeup transmission is a retransmission of a prior wakeup transmission for the group of stations based at least in part on an indication included in the first wakeup transmission. The operations of block 1515 may be performed according to the methods described herein. In certain examples, aspects of the operations of block 1515 may be performed by a retransmission manager as described with reference to FIGS. 6 through 9.

At block 1520 the STA 115 may refrain from powering on the second radio of the station to communicate with the access point in response to the first wakeup transmission based at least in part on the identifying that the indication that the first wakeup transmission is the retransmission of the prior wakeup transmission. The operations of block 1520 may be performed according to the methods described herein. In certain examples, aspects of the operations of block 1520 may be performed by a radio powering manager as described with reference to FIGS. 6 through 9.

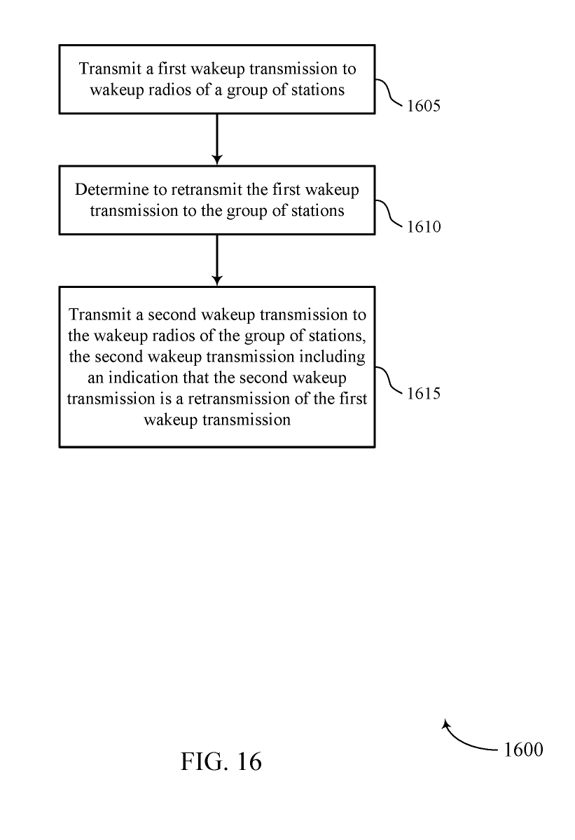

FIG. 16 shows a flowchart illustrating a method 1600 for efficient retransmissions for WUR in accordance with aspects of the present disclosure. The operations of method 1600 may be implemented by an AP105 or its components as described herein. For example, the operations of method 1600 may be performed by an AP communications manager as described with reference to FIGS. 10 through 13. In some examples, an AP105 may execute a set of codes to control the functional elements of the device to perform the functions described below. Additionally or alternatively, the AP 105 may perform aspects of the functions described below using special-purpose hardware.

At block 1605 the AP 105 may transmit a first wakeup transmission to wakeup radios of a group of stations. The operations of block 1605 may be performed according to the methods described herein. In certain examples, aspects of the operations of block 1605 may be performed by a wakeup transmission manager as described with reference to FIGS. 10 through 13.

At block 1610 the AP 105 may determine to retransmit the first wakeup transmission to the group of stations. The operations of block 1610 may be performed according to the methods described herein. In certain examples, aspects of the operations of block 1610 may be performed by a retransmission manager as described with reference to FIGS. 10 through 13.

At block 1615 the AP 105 may transmit a second wakeup transmission to the wakeup radios of the group of stations, the second wakeup transmission including an indication that the second wakeup transmission is a retransmission of the first wakeup transmission. The operations of block 1615 may be performed according to the methods described herein. In certain examples, aspects of the operations of block 1615 may be performed by a retransmission indication manager as described with reference to FIGS. 10 through 13.

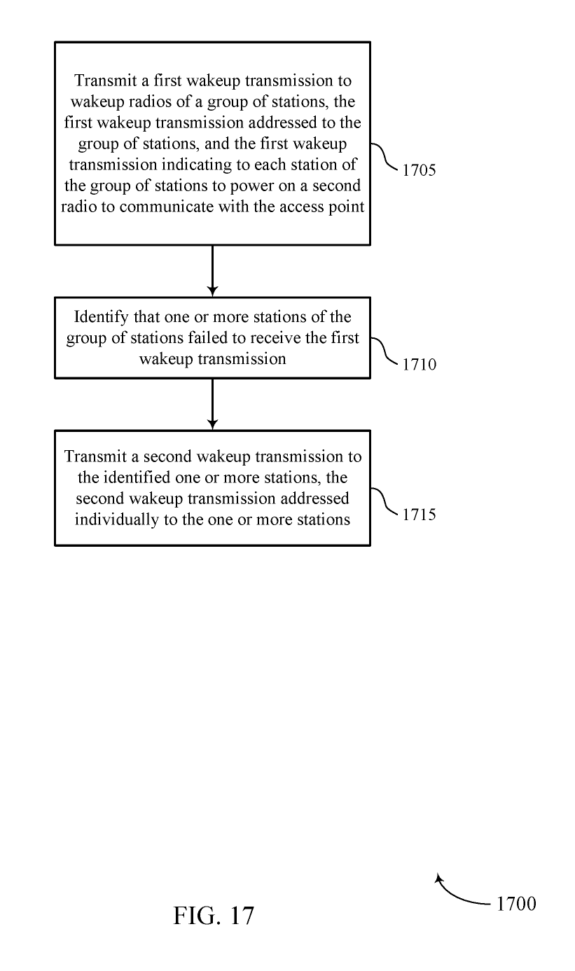

FIG. 17 shows a flowchart illustrating a method 1700 for efficient retransmissions for WUR in accordance with aspects of the present disclosure. The operations of method 1700 may be implemented by an AP105 or its components as described herein. For example, the operations of method 1700 may be performed by an AP communications manager as described with reference to FIGS. 10 through 13. In some examples, an AP105 may execute a set of codes to control the functional elements of the device to perform the functions described below. Additionally or alternatively, the AP 105 may perform aspects of the functions described below using special-purpose hardware.

At block 1705 the AP 105 may transmit a first wakeup transmission to wakeup radios of a group of stations, the first wakeup transmission addressed to the group of stations, and the first wakeup transmission indicating to each station of the group of stations to power on a second radio to communicate with the access point. The operations of block 1705 may be performed according to the methods described herein. In certain examples, aspects of the operations of block 1705 may be performed by a wakeup transmission manager as described with reference to FIGS. 10 through 13.

At block 1710 the AP 105 may identify that one or more stations of the group of stations failed to receive the first wakeup transmission. The operations of block 1710 may be performed according to the methods described herein. In certain examples, aspects of the operations of block 1710 may be performed by a transmission failure manager as described with reference to FIGS. 10 through 13.

At block 1715 the AP 105 may transmit a second wakeup transmission to the identified one or more stations, the second wakeup transmission addressed individually to the one or more stations. The operations of block 1715 may be performed according to the methods described herein. In certain examples, aspects of the operations of block 1715 may be performed by a retransmission manager as described with reference to FIGS. 10 through 13.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, comprising:
a memory that stores instructions; and
a processor coupled with the memory, wherein the processor and the memory are configured to:
receive, at a wakeup radio of a station, a first wakeup transmission addressed to a group of stations that includes the station, wherein the first wakeup transmission indicates to the station to power on a second radio of the station to communicate with an access point; and
identify that the first wakeup transmission is a retransmission of a prior wakeup transmission for the group of stations based at least in part on an indication included in the first wakeup transmission.

2. The apparatus of claim 1, wherein the processor and memory are configured to:
determine that the station failed to receive the prior wakeup transmission; and
power on the second radio of the station to communicate with the access point based at least in part on receiving the first wakeup transmission.

3. The apparatus of claim 1, wherein the processor and memory are configured to:
receive, at the wakeup radio of the station, the prior wakeup transmission; and
refrain from powering on the second radio of the station to communicate with the access point in response to the first wakeup transmission based at least in part on the identifying that the indication that the first wakeup transmission is the retransmission of the prior wakeup transmission.

4. The apparatus of claim 1, wherein the indication that the first wakeup transmission is the retransmission of the prior wakeup transmission comprises a first sequence number.

5. The apparatus of claim 4, wherein the processor and memory are configured to identify that the first wakeup transmission is the retransmission of the prior wakeup transmission for the group of stations by being configured to:
compare the first sequence number included in the first wakeup transmission to a second sequence number in the prior wakeup transmission.

6. The apparatus of claim 4, wherein the first sequence number is included in a type dependent control field of the first wakeup transmission.

7. The apparatus of claim 1, wherein:
the first wakeup transmission is scrambled based at least in part on a scrambling sequence;
the processor and memory are configured to identify that the first wakeup transmission is the retransmission of the prior wakeup transmission for the group of stations by being configured to identify a successful descrambling sequence of one or more candidate descrambling sequences; and
the processor and memory are configured to determine that the first wakeup transmission is the retransmission of the prior wakeup transmission based at least in part on the identified successful descrambling sequence.

8. The apparatus of claim 1, wherein the first wakeup transmission comprises a unicast transmission addressed to the station.

9. The apparatus of claim 1, wherein the processor and memory are configured to:
receive an indication of a time window for the first wakeup transmission.

10. The apparatus of claim 9, wherein the time window is for wakeup transmissions that are broadcast, or multicast, or a combination thereof.

11. The apparatus of claim 9, wherein the time window comprises a periodicity, an offset from a reference point in time, a length of the time window, or a combination thereof.

12. The apparatus of claim 1, wherein the first wakeup transmission is received in a first time window and the prior wakeup transmission is received in a prior transmission window.

13. The apparatus of claim 1, wherein the apparatus is a wireless communication terminal and further comprises an antenna and a transceiver.

14. An apparatus for wireless communication, comprising:
a memory that stores instructions; and
a processor coupled with the memory, wherein the processor and the memory are configured to:
transmit a first wakeup transmission to wakeup radios of a group of stations;
determine to retransmit the first wakeup transmission to the group of stations; and
transmit a second wakeup transmission to the wakeup radios of the group of stations, the second wakeup transmission including an indication that the second wakeup transmission is a retransmission of the first wakeup transmission.

15. The apparatus of claim 14, wherein the indication that the second wakeup transmission is the retransmission of the first wakeup transmission comprises a sequence number.

16. The apparatus of claim 15, wherein the sequence number is included in a type dependent control field of the first wakeup transmission.

17. The apparatus of claim 14, wherein the processor and memory are configured to:
scramble, based at least in part on a first scrambling sequence, at least a portion of the first wakeup transmission prior to transmitting the first wakeup transmission; and
scramble, based at least in part on the first scrambling sequence, at least a portion of the second wakeup transmission prior to transmitting the second wakeup transmission to provide the indication that the second wakeup transmission is the retransmission of the first wakeup transmission.

18. The apparatus of claim 14, wherein the second wakeup transmission comprises a unicast transmission addressed to a station of the group of stations.

19. The apparatus of claim 14, wherein the processor and memory are configured to:
transmit an indication of a time window for the first wakeup transmission.

20. The apparatus of claim 19, wherein the time window is for wakeup transmissions that are broadcast, or multicast, or a combination thereof.

21. The apparatus of claim 19, wherein the time window comprises a periodicity, an offset from a reference point in time, a length of the time window, or a combination thereof

22. An apparatus for wireless communication, comprising:
a memory that stores instructions; and
a processor coupled with the memory, wherein the processor and the memory are configured to:
transmit a first wakeup transmission to wakeup radios of a group of stations, the first wakeup transmission addressed to the group of stations, and the first wakeup transmission indicating to each station of the group of stations to power on a second radio to communicate with the apparatus;
identify that one or more stations of the group of stations failed to receive the first wakeup transmission; and
transmit a second wakeup transmission to the identified one or more stations, the second wakeup transmission addressed individually to the one or more stations.

23. The apparatus of claim 22, wherein the second wakeup transmission is a retransmission of the first wakeup transmission.

24. The apparatus of claim 22, wherein the second wakeup transmission addressed individually to the one or more stations comprises a unicast transmission or a multicast transmission.

25. The apparatus of claim 22, wherein the processor and memory are configured to:
transmit an indication of a time window for the first wakeup transmission.

26. A method for wireless communication at a station, comprising:
receiving, at a wakeup radio of the station, a first wakeup transmission addressed to a group of stations that includes the station, wherein the first wakeup transmission indicates to the station to power on a second radio of the station to communicate with an access point; and
identifying that the first wakeup transmission is a retransmission of a prior wakeup transmission for the group of stations based at least in part on an indication included in the first wakeup transmission.

27. The method of claim 26, further comprising:
determining that the station failed to receive the prior wakeup transmission; and
powering on the second radio of the station to communicate with the access point based at least in part on receiving the first wakeup transmission.

28. The method of claim 26, further comprising:
receiving, at the wakeup radio of the station, the prior wakeup transmission; and
refraining from powering on the second radio of the station to communicate with the access point in response to the first wakeup transmission based at least in part on the identifying that the indication that the first wakeup transmission is the retransmission of the prior wakeup transmission.

29. The method of claim 26, wherein the indication that the first wakeup transmission is the retransmission of the prior wakeup transmission comprises a sequence number.

30. The method of claim 26, further comprising:
receiving an indication of a time window for the first wakeup transmission, the time window for wakeup transmissions that are broadcast, or multicast, or a combination thereof.
